(19) United States
(12) Patent Application Publication
(10) Pub. No.: US 2009/0188153 A1
(43) Pub. Date: Jul. 30, 2009

(54) Saving the world from rats, mice and their deadly disease, the hanta virus and plague

(76) Inventor: Alexis N. Stevenson, Evergreen, CO (US)

Correspondence Address: Alexis N. Stevenson, P.O. Box 1298, Evergreen, CO, 80437, US

(21) Appl. No.: 12/001,193

(22) Filed: Jan. 30, 2008

(51) Int. Cl. A01M 23/08; A01M 23/02

(52) U.S. Cl. 43/65; 43/64

(57) ABSTRACT

This unique, chemical-free, environmentally-friendly, No contamination, or poison

The ultimate Trap contains two sections the upper section has Two parts A, and B.

A, which is the portable pitch roof stayle to carry the bait Above the drowning hole to the second section. —B—

The B, section is contain the two slippery slopes Ramb they go Down from zero To 8, inches or more. To get Rats, Mice to the Lower section(Tank) through 6,inches hole.

The lower section is filled with water to drown and suffocated The rats,mice, mission accomplished.

For the jampo Rats we need to use Tazer device with motion sensor Work when their is a visiters (jampo Rats).

To deliver electric shock to the jampo Rats and make them drowsy And send them to their death to the lower section(Tank).

Filled with water to drown them and finished the job.

### SUMMARY OF THE INVENTION

Rodents they will be with us since life was created they are in Our homes, farms, supermarkets, restaurants, city streets, sewer, And street garbage containers, etc.

They Do contaminate our food with their urine, drops, saliva and Their flies increasing the risk of infectious they carry with Them which is giving Us and the Wild life that deadly diseases The hanta virus and plague.

They create catastrophic disaster back at the roman empire with Their deadly diseases by infecting the people and left them Dead in three days also they create more catastrophic disaster In Asia and around the World from time to time so we need to Take them seriously and clean our plant from their preant and Make the World saver.

People in the pass they use their dogs to catch the Rodents and Killed them But they create bigger problem by infecting their Dogs with their flies.

### SUMMARY OF THE INVENTION

This unique, chemical-free, environmentally-friendly, No contamination, or poison.

It is guaranteed to capture unlimited amount of Rodents and drown Them.

Jampo Rats;

When the jampo Rats climb-up to get a bite in side the trap Immediately they get electric shock by Tazer devices sensor Make them drowsy and send them down to their death by drowning Them and finished the jop.

### BRIEF DESCRIPTION OF THE DRAWINGS

This unique, chemical-free, environmentally-friendly.

No contamination, or poison. contains two sections the upper Section has two parts A, and B.

FIG. 1, is the portable top section pitch roof stayle with two pins dowel for mounting on the top of section —B— To carry the bait in the center.

FIG. 2, when rats,mice climb to the upper section —B— to get a bite for the irresistable smell they immediatly slide down to their death to the lower section.

the —B— section it is clossed from the out side.

top side is open to carry the portable bait hanger.

inside the box you find the two slippery slopes to get the rats,mice to the lower tank through 6 inches hole to the lower section.

this section —B— will set on top of the lower tank.

FIG. 3, the lower tank is filled with water to drown, suffocated, the rats, mice and finished the job.

the trap has a drain and shut-off valve for ease of use and clean-up.

FIG. 4, when the jampo rats climb to the upper section to get a bite for irresistable smell they will get electric shock by a tazer device to make them drowsy and send them to their death. this is for jampo rats only.

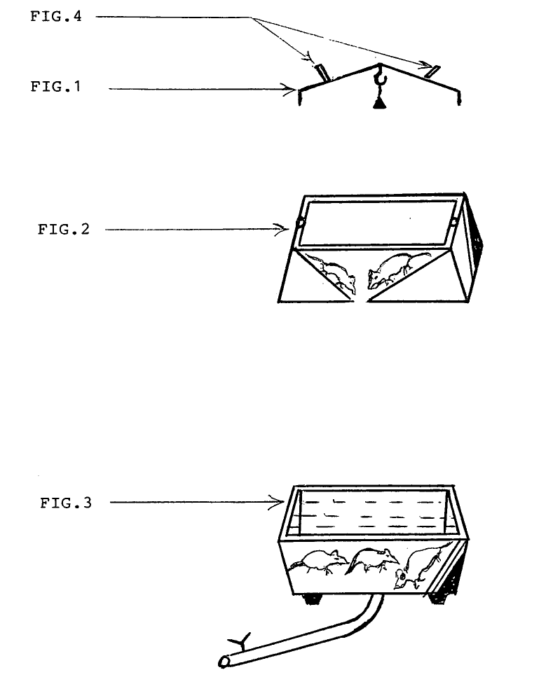

What i claim is:

1. This ground-breaking invention will be very effective in Getting rid of Rats, Mice from our homes, restaurants, Supermarkets, city streets, sewers and street garbage containers, Etc.
Rats and mice they will climb to the second section becauses the Irresistable smell to get a bite But unfortunately they would Not have the chance to do so because they immediatly slide down To their death to the second section (Tank). through 6 inches hole The second section (Tank) filled with water to drown And suffocated the Rats and Mice.
This unique, chemical-free, environmentally-friendly safe trap Contains two sections the upper section has two parts A, and B, A, section which is the portable pitch roof stayle to carry The bait above the drowning hole to the second section —B—.
The B, section is contain the Two slippery slopes Ramb they go Down from zero To 8 inches or more. To get Rats, Mice to the Lower section(Tank) through 6 inches hole.
The lower section (Tank) is filled with water to drown and Suffocated them. and finished the job.
The tank has drain and shut-off valve for ease of use and Clean-up.
To get to the biggest (jampo rats) In our cities.
Rats the size of a cat we need to be very aggressive with them Because they are very strong and dangerous so we need To Tazer them.
The tazer will deliver electrical shock to the jampo Rats and Make them drowsy and send them to their death to the lower Section which is filled with water to drown, suffocated them, And finished the job.
In the end this is the ultimate Invention ever chemical-free, Environmentally friendly,no contamination, or poison.
100% Guaranteed To capture unlimited amount of Rodents and Drown them. and clean our plant from their present.
